(19) United States
(12) Patent Application Publication
(10) Pub. No.: US 2026/0024366 A1
(43) Pub. Date: Jan. 22, 2026

(54) Processing of images with text

(71) Applicant: Canva Pty Ltd, Surry Hills (AU)

(72) Inventors: Sanchit Sanchit, Vienna (AT); Alexander Tack, Vienna (AT)

(73) Assignee: Canva Pty Ltd, Surry Hills (AU)

(21) Appl. No.: 19/270,211

(22) Filed: Jul. 15, 2025

(30) Foreign Application Priority Data
Jul. 16, 2024 (AU) 2024204885

(51) Int. Cl. G06V 30/244; G06V 10/44; G06V 10/764; G06V 10/776; G06V 10/82; G06V 30/148; G06V 30/18; G06V 30/19; G06V 30/414

(52) U.S. Cl. CPC G06V 30/245; G06V 10/443; G06V 10/764; G06V 10/776; G06V 10/82; G06V 30/153; G06V 30/18; G06V 30/18019; G06V 30/18152; G06V 30/19173; G06V 30/414

(57) ABSTRACT

Image processing techniques are described, including techniques in which text data associated with an image is used to determine a font of text in an image. The image is split into a plurality of crops based on the text data. A trained machine learning model is used to determine feature vectors of the image. The feature vectors are combined into a combined feature vector. A second trained machine learning model is used to determine a font using the combined feature vector. The second trained machine learning model may be a multi-layer perceptron network. The second trained machined learning model may be trained on a plurality of images with text of known fonts and properties. The described image processing techniques also include text removal.

### CROSS REFERENCE TO RELATED APPLICATION

This application is a U.S. Non-Provisional application that claims priority to Australian Patent Application No. 2024204885, filed on Jul. 16, 2024, which is hereby incorporated by reference in its entirety.

### TECHNICAL FIELD

The present disclosure relates to the field of image processing, in particular processing of images including text. Some aspects of the present disclosure are directed to systems and methods for processing an image to recognise or remove text in the image. Particular embodiments relate to creating a document with editable text that corresponds to text visible in an image. Particular embodiments relate to methods of removing text from an image.

### BACKGROUND

Various devices for creating image documents exist. One example is a camera to generate digital photographs. Another example is a computer application that allows a user of the application to create a document incorporating a design and save, print or publish the design as an image document. A further example is a trained machine learning algorithm, which might generate an image document based on a text prompt.

Images may contain text. For example, an image of a poster, banner or other design may include text. It is often a requirement to determine the content of the text, for example for searching operations or for creating a document in which the text is extracted and made editable using a text editor rather than an image editor. In addition to determining the content of the text, it may be useful to determine the font of the text. For example, when creating a document in which the text is editable, a font may be used for the editable text that is the same as or similar to the font in the image. It may also or instead be a requirement to remove text included in an image.

### SUMMARY

The present disclosure generally relates to computer implemented methods for recognising or estimating one or more characteristics of text in an image. The methods include using a trained machine learning model to determine the one or more characteristics based on portions of the image that are associated with text.

At least one of the portions of the image may be non-square and may be elongate in the direction of text. Two or more, up to all, of the portions of the image may be non-square and elongate in the direction of text.

An example application of the methods of the present disclosure is recognising or estimating a font of the text. The recognised or estimated font may then be used to create an editable document that includes editable text in the recognised or estimated font. The editable document may include the image and the editable text may be located at a location corresponding to said portions of image. Those portions may be inpainted, so that the result is to remove the original image text and replace it with editable text.

Described herein are computer implemented methods for determining a font for text in an image. The methods include: extracting a plurality of crops of an image, the plurality of crops including at least one non-square crop of the image, wherein each non-square crop of the image is located within a group text area, the group text area encompassing a group of the text in the image and determined based on text data associated with the image, the text data comprising location information for text in the image; determining, by a first trained machine leaning model, a feature vector for each of the crops of the image; combining the feature vectors to form a combined feature vector; determining, by a second trained machine learning model provided with the combined feature vector as an input, a class probability value for each of a plurality of classes, the plurality of classes corresponding to fonts; and determining a font for the group of text in the image as the font having the highest determined class probability value.

In some embodiments the text data comprises optical character recognition (OCR) text generated by an OCR process and wherein the location information comprises bounding boxes for the OCR text, each bounding box having a location with reference to the image that provides information on a location in the image of the OCR text, and wherein the group text area is an area occupied by one or more of the bounding boxes for the group of text.

In some embodiments the method further comprises determining the group of the text in the image for a said crop of the image by a method comprising: either receiving in the text data, data identifying a line of the text, or identifying a line of the text based on the text data; and determining the group of text as the line of the text or a part of the line of the text.

In some embodiments a first of the plurality of crops of the image is a portion of the image corresponding to a first portion of the group of text; and a second of the plurality of crops of the image is a portion of the image corresponding to a second portion of the group of text, different to the first portion of the group of text.

In some embodiments a third of the plurality of crops of the image is a portion of the image corresponding to a third portion of the group of text, different to the first portion of the group of text and different to the second portion of the group of text.

In some embodiments the group of text has a landscape orientation and the first, second and third portions correspond to a left-most portion, a middle portion and a right-most portion respectively of the group of text.

In some embodiments the group of text has a portrait orientation and the first, second and third portions correspond to a top-most portion, a central portion and a bottom-most portion respectively of the group of text.

In some embodiments the group of text is determined as a part of the line of text and wherein the part of the line of text is determined as a predetermined number of words in the line of text.

In some embodiments each of the crops of the image are located at a different said location within the group text area.

In some embodiments the crops are distributed across the group text area.

In some embodiments the method further includes determining that the group text area has an aspect ratio equal to an aspect ratio of the crops of the image and in response extracting the group text area as each of the plurality of crops of the image.

In some embodiments each of the plurality of crops of the image are resized to a predetermined standard size while maintaining aspect ratio, prior to determining the feature vector for the crop.

In some embodiments the first trained machine learning model comprises a convolutional neural network, with global average pooling of 3D convolutional features to form a 1D feature vector for each of the non-square crops of the image.

In some embodiments combining the feature vectors is by either concatenation or summation.

In some embodiments the second trained machine-learning model is a classification multi-layer perceptron (MLP) network.

In some embodiments the MLP network is a 2-hidden layered MLP network.

In some embodiments the MLP network was trained by a process comprising computing multi-class cross entropy loss between determined class probability values and a ground-truth class probabilities.

In some embodiments the at least one non-square crop has a size dimension along a long axis three times that of a corresponding size dimension along a short axis.

In some embodiments each of the crops of the image are non-square crops.

In some embodiments each of the non-square crops have the same aspect ratio.

In some embodiments the method further comprises creating an editable document, the editable document comprising the image and editable text located over the image at the group text area, the editable text having the determined font.

In some embodiments the method further comprises editing the editable document by a text editor, wherein the text editor has, as available fonts, fonts matching the fonts with corresponding classes.

In some embodiments creating an editable document comprises inpainting over the group of the text in the image on a pixel-by-pixel basis, wherein the pixels for inpainting are identified by applying a trained binary segmentation model that has been trained to with reference to a binary segmentation problem of which pixels an image portion belong to one or more text parts of the image and which pixels belong to one or more non-text parts of the image portion.

Also described is a computer implemented method including: creating or receiving a machine learning training set of combined feature vectors for a plurality of different word images, wherein: each word image comprises: text forming one or more words or other text units, which are arranged along a line; and a background; the text of each word image is in one of a plurality of known fonts or one of a plurality of known fonts with modifications; and a plurality of the word images are formed by more than one word or other text unit; the combined feature vectors are formed based on the plurality of different word images by a process comprising: extracting a plurality of crops of a first word image of the plurality of word images, the plurality of crops including at least one non-square crop, each non-square crop having a long axis along the line and a short axis perpendicular to the line; determining, by a first trained machine learning model, a feature vector for each of the crops of the image; combining the feature vectors to form a said combined feature vector for the first word image; using the machine learning training set to train a second machine learning model, by a process comprising: providing the machine learning training set as an input to the second machine learning model and determining by the second machine learning model a class probability value for each of a plurality of classes, the plurality of classes corresponding to the plurality of known fonts; and determining from the class probability values a classification loss relative to the known font; training the second machine learning model based on the classification loss.

In some embodiments the plurality of different word images include word images with different numbers of words or other text units.

In some embodiments, the number of words or other text units in a word image was selected by a random or quasi-random selection process.

In some embodiments the word images include images with the text all in uppercase and images with the text all in lowercase.

In some embodiments the text of a said word image has a case that was selected by a random or quasi-random selection process.

In some embodiments the random or quasi-random selection process for the case of text, the probability of uppercase or is lower than the probability of lowercase.

In some embodiments the text of a said word image has a combination of uppercase and lowercase.

In some embodiments the random or quasi-random selection process for the case of the text, the probability of all uppercase or all lowercase is higher than the probability of a combination of both uppercase and lowercase.

In some embodiments each of the one or more words or other text units in a word image were selected by a random or quasi-random selection process.

In some embodiments the background for each word image was selected by a random or quasi-random selection process.

In some embodiments each word or other text unit in the plurality of the word images formed by more than one word or other text unit is spaced apart in the line from an adjacent word or other text unit by a gap and wherein the gap was selected by a random or quasi-ransom selection process.

In some embodiments at least one word image was formed by alpha-blending an image of the text and a background image.

In some embodiments the method further includes, for the at least one word image, applying at least one type of distortion to the image of the text before the alpha-blending.

In some embodiments the method, further includes, for the at least one word image, applying a transparency to the image of the text before the alpha-blending, wherein the applied transparency was selected by a random or quasi-random selection process.

In some embodiments the method further includes, for the at least one word image, applying an arc bending to the image of the text before the alpha-blending, wherein the applied arc bending was selected by a random or quasi-random selection process.

In some embodiments, at least one word image was formed by a process comprising applying at least one of a JPEG compression of various compression rates, Down-sampling followed by up-sampling, random cropping, Gaussian noise and colour distortions.

In some embodiments the at least one non-square crop has a size dimension along the long axis three times that of a corresponding size dimension along the short axis.

In some embodiments the text has a landscape orientation and the plurality of crops comprise or consist of a left-most portion, a middle portion and a right-most portion of the text.

In some embodiments the text has a portrait orientation and the plurality of crops comprise or consist of an upper-most portion, a centre portion and a lower-most portion of the text.

In some embodiments the second trained machine learning model was trained by a method described herein.

Also described is a computer-implemented method for text removal for an image, the method including: a) detecting and recognizing text present in an image using optical character recognition (OCR); b) extracting word images from the image, the word images being at a location and having a dimension based on bounding boxes provided by the OCR; c) applying a trained binary segmentation model to the extracted word images to identify pixels belonging to the text and pixels belonging to the background; d) masking out the text pixels in the extracted word images to obtain masked word images; and e) in-painting the masked-out text regions in the masked word images using a generative image inpainting model. This method for text removal may be used, for example, to effect inpainting of portions of an image that includes a recognised or estimated font as described herein.

In some embodiments the method, further includes adding to the image editable text that is editable by a text editor, the editable text corresponding to the recognised text. The corresponding text editable by a text editor may have a font determined according to a font determination method described herein.

Other computer-implemented methods will be apparent from the following detailed description and the accompanying figures, as well as systems for implementing the methods and non-transitory computer readable storage containing instructions that cause a computer system to perform the methods.

### BRIEF DESCRIPTION OF THE DRAWINGS

FIGS. 1A-B depict example designs and FIG. 1C depicts lines and paragraphs associated with the design of FIG. 1B.

FIG. 2 is a diagram depicting a computing environment in which various features of the present disclosure may be implemented.

FIG. 3 is a block diagram of a computer processing system configurable to perform various features of the present disclosure.

FIG. 4 depicts an example design user interface.

FIG. 5 depicts processes performed in a method for determining a font in an image.

FIG. 6 depicts processes performed in a method for creating non-square crops of a text image.

FIG. 7 depicts an example of a process of cropping a text image.

FIG. 8 depicts an example process of determining a font from crops of an image.

FIG. 9 depicts processes performed in a method for training a machine learning model to determine fonts.

FIG. 10 depicts processes performed in a method for creating an image with text editable by a text editor.

FIG. 11 depicts an example of a process for text removal for an image.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present disclosure as defined by the appended claims.

### DETAILED DESCRIPTION

In the following description numerous specific details are set forth in order to provide a thorough understanding of the present disclosure. It will be apparent, however, that the present disclosure may be practiced without these specific details. In some instances, well-known structures and devices are shown in block diagram form in order to avoid unnecessary obscuring.

Computer applications for use in creating documents incorporating designs are known. Such applications will typically provide various functions that can be used in creating and editing designs. For example, such design editing applications may provide users with the ability to edit an existing design by deleting elements of the existing design that are not wanted; editing elements of the existing design that are of use, but not in their original form or location within the design; and adding new elements. Where there are design elements in the design that are in the form of text, the design editing application may include a text editor, which allows for the text to be edited, for example through amendment of the symbols (e.g. letters, numbers or characters) in the text. These editing operations may be achieved through a keyboard entry. For example to enter new symbols a user may press the required symbols on a keyboard, such as depressing the letter “A” to insert “a” or “A”. Similarly a user may select delete or backspace to remove text. In addition, the properties of the text may be edited, for example through amendment of the font, which may be an amendment of one or more of: the font style, type, size, colour or position, whether the text is underlined or in bold, whether the text includes effects like strike-through or shadowing and so forth. The amendment may also or instead be an amendment of the paragraph type (e.g. left-aligned, centre-aligned, right-aligned or justified). These operations may be through a menu structure of the text editor, navigated by a point-and-click device or through a keyboard shortcut.

Typically a design editing application is configured to create documents in one or more specific formats. The design editing application includes functionality to open a document saved in of the specific formats, make edits to the document and save the edited document into the same format or into another one of the specific formats. The design editing application may have some functionality to edit documents that are image files or to edit images within the document, but often this functionality is limited.

The present disclosure provides techniques for processing an image document to create a modified image document with editable text within it or with text in the image removed (or both). In particular, the modified image document preserves at least some or all of the image and includes editable text within the image or has the text matter of the image removed. The editable text may correspond to or estimate text in the image document. For example, the editable text may be edited using typical text editing functions of a text editor within a design editing application, like amendment to the letters, numbers or characters and amendment to the properties of the text. This form of editing is typically much easier and more efficient than image editing techniques using an image editor to achieve a similar result.

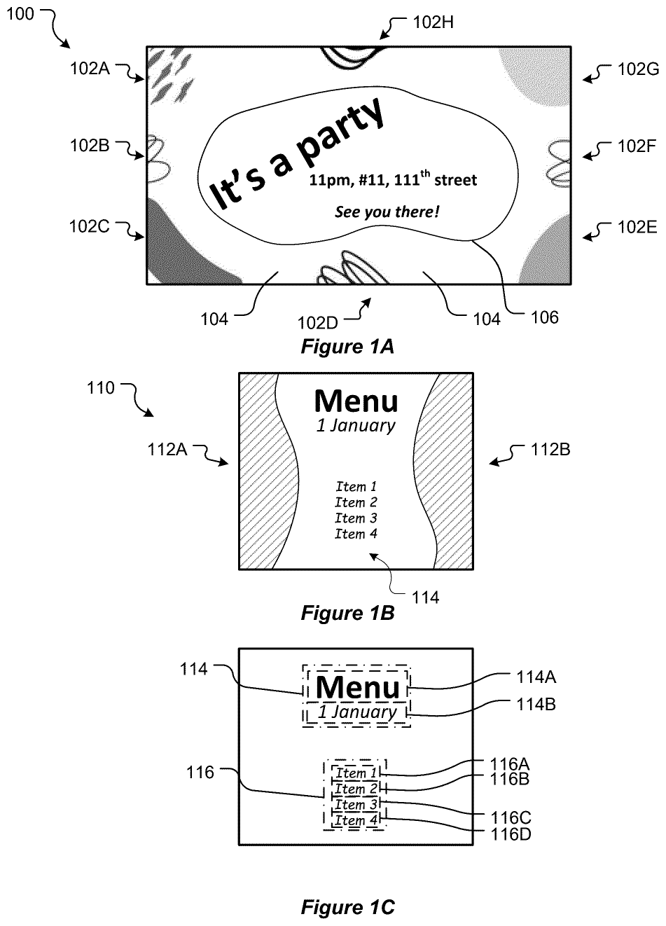

In order to illustrate this, consider a scenario in which an image document is received that has a design 100 as shown in FIG. 1A or a design 110 as shown in FIG. 1B.

The design 100 is a party invitation design that includes various decorations 102A-102H, a solid background fill 104 of a particular colour and an internal closed curve element 106 that includes within it text of “It's a party”, “1 pm, #11, 111^{th} street”, and “See you there!”. A person may wish to use the design 100 for another event or for their own event and to do so requires different text. The design 110 is a menu design that includes two decorations 112A and 112B and a set of text 114 reading “Menu”, “1 January”, “Item 1”, “Item 2”, “Item 3”, and “Item 4”. Similarly, a person may wish to use design 100 for another day, so wish to edit the date and the items in the menu.

As the designs 100, 110 are in respective image documents it would be cumbersome to edit the text of each using an image editor. The present disclosure relates to various functions that create, or are usable for the creation of, a modified image document that incorporates at least part of the design 100 or design 110 and in which the text is editable using text editing operations of a text editor, as opposed to image editing operations of an image editor. The present disclosure does not however exclude the option to use an image editor, in addition to the use of a text editor. For example editing operations of text may be performed using a text editor and then refined using an image editor.

The functions disclosed herein are described in the context of a design platform that is configured to facilitate various operations concerned with digital image documents. In the context of the present disclosure, these operations relevantly include processing digital image documents to identify characteristics of the document and utilising the identified characteristics to create a modified image document incorporating text editable using a text editor.

A design platform may take various forms. In the embodiments described herein, the design platform is described as a stand-alone computer processing system (e.g. a single application or set of applications that run on a user's computer processing system and perform the techniques described herein without requiring server-side operations). The techniques described herein can, however, be performed (or be adapted to be performed) by a client-server type computer processing system (e.g. one or more client applications on a user's computer processing system and one or more server applications on a provider's computer processing system that interoperate to perform the described techniques). It will be appreciated that the combination of two (or more) computer processing systems operating in a client-server arrangement may be viewed as a computer processing system made of two (or more) subcomponents that are the client side and server side computer processing systems.

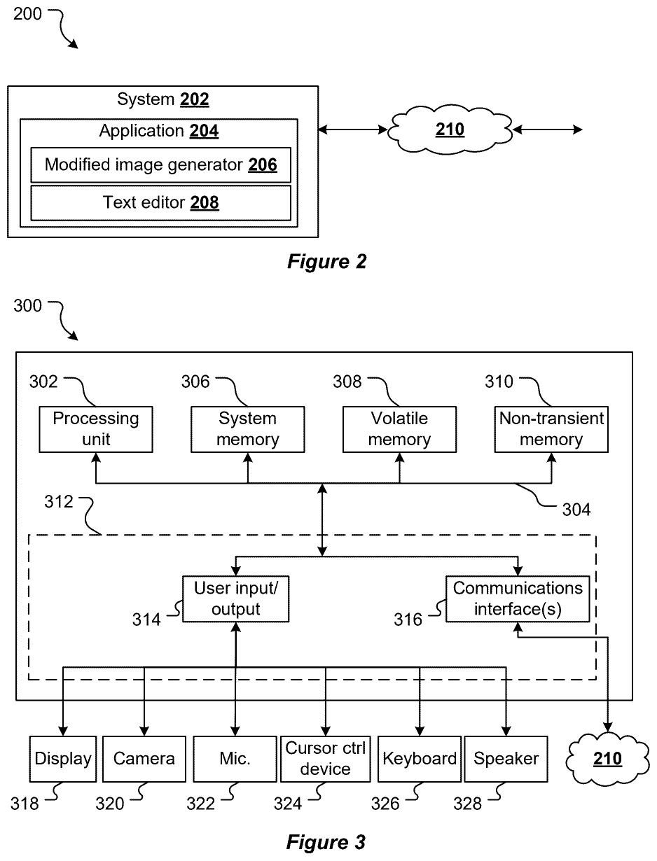

FIG. 2 depicts a system 202 that is configured to perform the various functions described herein. The system 202 may be a suitable type of computer processing system, for example a desktop computer, a laptop computer, a tablet device, a smart phone device, or an alternative computer processing system.

The system 202 is configured to perform the functions described herein by execution computer readable instructions that are stored in a storage device (such as non-transitory memory 310 described below) and executed by a processing unit of the system 202 (such as processing unit 302 described below). For convenience the set of computer readable-instructions is referred to as an application and also for convenience all functions are described as being in the same application, application 204 of system 202. It will be appreciated that the functions may be provided in one application or may be provided across what may be called two or more applications, or in part by functionality provided by an application that is an operating system of the system 202. By way of illustration, functionality to create a modified image document with editable text within it (modified image generator 206 in FIG. 2) and a text editor (text editor 208 in FIG. 2) to edit the text of the created editable document may be provided in the same application (application 204 in FIG. 2) or across two or more applications.

In the present example, application 204 facilitates various functions related to digital documents. As mentioned these may include functions to create an editable document from an image document, the editable document editable by a text editor to edit text. The functions may also include, for example, design creation, editing, storage, organisation, searching, storage, retrieval, viewing, sharing, publishing, and/or other functions related to digital documents.

In the example of FIG. 2, system 202 is connected to a network 210. The network 210 is a communications network, such a wide area network, a local network or a combination of a one or more wide and local area networks. Via network 210 system 202 can communicate with (e.g. send data to and receive data from) other computer processing systems (not shown). The techniques described herein can, however, be implemented on a stand-alone computer system that does not require network connectivity or communication with other systems.

The system 202 may include, and typically will include, additional applications (not shown). For example, and assuming application 204 is not part of an operating system application, system 202 will include a separate operating system application (or group of applications). The system 202 may also include an application for generating or receiving image documents, which application can make the image files available to the application 204, for example by storing the image documents in memory of the system 202. For example the system 202 may include a camera application for operating a camera (such as camera 320 described below) that is part of the system 202 or in communication with the system 202.

Turning to FIG. 3, a block diagram depicting hardware component of a computer processing system 300 is provided. The system 200 of FIG. 2 may be a computer processing system 300, though alternative hardware architectures are possible.

Computer processing system 300 includes at least one processing unit 302. The processing unit 302 may be a single computer processing device (e.g. a central processing unit, graphics processing unit, or other computational device), or may include a plurality of computer processing devices. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) system 300.

Through a communications bus 304 the processing unit 302 is in data communication with a one or more machine readable storage devices (also referred to as memory devices or just memory). Computer readable instructions and/or data (e.g. data defining documents) for execution or reading/writing operations by the processing unit 302 to control operation of the processing system 300 are stored on one or more such storage devices. In this example system 300 includes a system memory 306 (e.g. a BIOS), volatile memory 308 (e.g. random access memory such as one or more DRAM modules), and non-transitory memory 310 (e.g. one or more hard disk or solid state drives). Instructions and data may be transmitted to/received by system 300 via a data signal in a transmission channel enabled (for example) by a wired or wireless network connection over an interface such as communications interface 316.

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g. networked) connection. Generally speaking, and depending on the particular system in question, devices to which system 300 connects—whether by wired or wireless means—include one or more input devices to allow data to be input into/received by system 300 and one or more output device to allow data to be output by system 300.

By way of example, system 300 may include a display 318 (which may be a touch screen display and as such operate as both an input and output device), a camera device 320, a microphone device 322 (which may be integrated with the camera device), a cursor control device 324 (e.g. a mouse, trackpad, or other cursor control device), a keyboard 326, and a speaker device 328. For example a desktop computer or laptop may include these devices. As another example, where system 300 is a portable personal computing device such as a smart phone or tablet it may include a touchscreen display 318, a camera device 320, a microphone device 322, and a speaker device 328. As another example, where system 300 is a server computing device it may be remotely operable from another computing device via a communication network. Such a server may not itself need/require further peripherals such as a display, keyboard, cursor control device and so forth, though the server may nonetheless be connectable to such devices via appropriate ports. Alternative types of computer processing systems, with additional/alternative input and output devices, are possible.

System 300 also includes one or more communications interfaces 316 for communication with a network, such as network 210 of FIG. 1. Via the communications interface(s) 316, system 300 can communicate data to and receive data from networked systems and/or devices.

In some cases part or all of a given computer-implemented method will be performed by system 300 itself, while in other cases processing may be performed by other devices in data communication with system 300.

It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

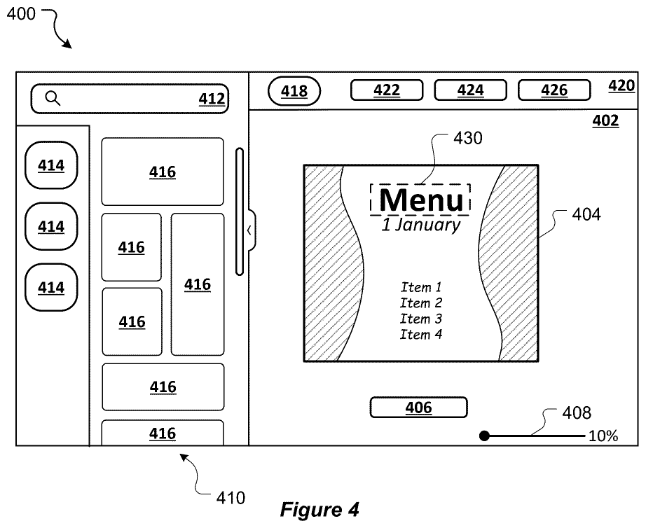

Referring to FIG. 1 and FIG. 4, application 204 configures the system 202 to provide an editor user interface 400 (UI). Generally speaking, UI 400 will allow a user to create, edit, and output documents. FIG. 4 provides a simplified and partial example of an editor UI that includes a text editor. In this example the editor UI 400 is a graphical user interface (GUI).

UI 400 includes a design preview area 402. Design preview area 402 may, for example, be used to display a page 404 (or, in some cases multiple pages) of a document. In this example, preview area 402 is being used to display a preview of design 120 of FIG. 1. The design 120 is part of a modified image document that includes editable text. The modified image document was created based on an image document including the same design 120, or a similar design to the design 120, in which the text was not editable by a text editor and instead part of the image (and editable by an image editor, but not by a text editor). Processes for creating such a modified image document are described elsewhere herein.

In this example an add page control 406 is provided (which, if activated by a user, causes a new page to be added to the design being created) and a zoom control 408 (which a user can interact with to zoom into/out of page currently displayed).

In some embodiments UI 400 also includes search area 410. Search area 410 may be used, for example, to search for assets that application 204 makes available to a user to assist in creating or editing designs, for example by inserting the asset into a design. The asset may include one or more or existing documents. For example, an existing document may be an image document, such as a photograph. Another existing document may be a modified image document, such as a photograph but modified so that text identified in the original photograph is editable. Different types of assets may also be made available, for example design elements of various types (e.g. text elements, geometric shapes, charts, tables, and/or other types of design elements), media of various types (e.g. photos, vector graphics, shapes, videos, audio clips, and/or other media), design templates, design styles (e.g. defined sets of colours, font types, and/or other assets/asset parameters), and/or other assets that a user may use when creating or editing a document including a design.

In this example, search area 410 includes a search control 412 via which a user can submit search data (e.g. a string of characters). Search area 410 of the present example also includes several type selectors 414 which allow a user to select what they wish to search for—e.g. existing documents and/or various types of design assets that application 204 may make available for a user to assist in creating or editing a design (e.g. design templates, photographs, vector graphics, audio elements, charts, tables text styles, colour schemes, and/or other assets). When a user submits a search (e.g. by selecting a particular type via a type control 414 and entering search text via search control 412) application 204 may display previews 416 (e.g. thumbnails or the like) of any search results.

Depending on the implementation, the previews 416 displayed in search area 410 (and the design assets corresponding to those previews) may be accessed from various locations. For example, the search functionality invoked by search control 412 may cause application 204 to search for existing designs and/or assets that are stored in locally accessible memory of the system 202 on which application 204 executes (e.g. non-transitory memory such as 310 or other locally accessible memory), assets that are stored at a remote server (and accessed via a server application running thereon), and/or assets stored on other locally or remotely accessible devices.

UI 400 also includes an additional controls area 420 which, in this example, is used to display additional controls. The additional controls may include one or more: permanent controls (e.g. controls such as save, download, print, share, publish, and/or other controls that are frequently used/widely applicable and that application 204 is configured to permanently display); user configurable controls (which a user can select to add to or remove from area 420); and/or one or more adaptive controls (which application 204 may change depending, for example, on the type of design element that is currently selected/being interacted with by a user).

For example, the controls area 420 may include controls of a text editor. These controls may, for example, include controls that are utilisable by a user for changing the letters, numbers or characters of text in the design 120 or for editing the properties of the text. If the controls area 420 displays adaptive controls, these text editing controls may be displayed responsive to a text element being selected, for example user selection of a text box 430 containing text, in this case “Menu”, which was identified as part of the set of text 114. In some embodiments a cursor or similar (not shown in FIG. 4) is displayed to indicate where text that is entered by a user will be placed (e.g. using a keyboard). The cursor may be displayed, for example, responsive to user input that indicates a potential requirement to enter or change or delete text in the text box 430 (or other text in the design 120).

In some embodiments one or more of the controls in the control area 420 (or elsewhere in the UI 400) provide access to a plurality of options. For example, user selection of the control 422 may cause the display of a list of available fonts (e.g. Times New Roman, Arial, Cambria etc). Control 424 may display a list of font sizes (e.g. 8 points, 10 points, 11, points, 12 points etc). Control 426 may display a list of options (e.g. other properties such as bold, underline, strikethrough, adding shadows etc). It will be appreciated that many other options for text editing may be provided, including options that incorporate two or more property settings, for example to set a style of text as being a particular font of a particular size in bold and italics. Many such options are known from existing text editors.

The controls area 420 may include one or more controls for invoking or initiating a process for creating a modified image document with editable text or with text removed (or both), based on an original image document without editable text. In the example of FIG. 4 selection of control 418 when an image file is displayed in the design preview area 402 may cause the creation of a modified image document. The modified image document may be displayed in the design preview area 402, to enable editing, saving and other operations. In some embodiments this display of the modified image document occurs without further user input following selection of the control 418. For example, the original image document may have been an image document showing the design 110 without text boxes containing editable text and the modified image document may include text boxes and editable text, including the text box 430. The functionality to generate a modified image document with editable text or with text removed may also or instead be provided by a separate application. That application may make the modified image document available to the application 204, for example by saving it to a storage location accessible by the application 204.

Application 204 may provide various options for outputting a design. For example, application 204 may provide a user with options to output a design by one or more of: saving a document including the design to local memory of system 202 (e.g. non-transitory memory 310); saving the document to remotely accessible memory device; uploading the document to a server system; printing the document to a printer (local or networked); communicating the document to another user (e.g. by email, instant message, or other electronic communication channel); publishing the document to a social media platform or other service (e.g. by sending the design to a third party server system with appropriate API commands to publish the design); and/or by other output means.

Data in respect of documents including designs that have been (or are being) created or edited may be stored in various formats. An example document data format that will be used throughout this disclosure for illustrative purposes will now be described. Alternative design data formats (which make use of the same or alternative design attributes) are, however, possible, and the processing described herein can be adapted for alternative formats.

In the present context, data in respect of a particular document is stored in a document record. In the present example, the format of each document record is a device independent format comprising a set of key-value pairs (e.g. a map or dictionary). To assist with understanding, a partial example of a document record format is as follows:

| Attribute | Example |
|---|---|
| Document ID | “docId”: “abc123” |
| Dimensions | “dimensions”: {“width”: 1080, “height”: 1080} |
| Document | “name”: “Test Doc 3” |
| name | |
| Background | “background”: {“mediaID”: “M12345”} |
| Element data | “elements”: [{element 1}, . . . {element n}] |

In this example, the design-level attributes include: a document identifier (which uniquely identifies the design); dimensions (e.g. a default page or image width and height), a document name (e.g. a string defining a default or user specified name for the design), background (data indicating any page background that has been set, for example an identifier of an image that has been set as the page background) and element data defining any elements of the design. Additional and/or alternative attributes may be provided, such as attributes regarding the type of document, creation date, design version, design permissions, and/or other attributes.

In this example, the element data of a document is a set (in this example an array) of element records ({element 1} to {element n}). Each element record defines an element (or a set of grouped elements) that has been added to the page. The element record identifies the attributes of the element, including the content of the element and a position of the element. The element records may also identify the depth or z-index of the element and the orientation of the element.

Generally speaking, an element record defines an object that has been added to a page—e.g. by copying and pasting, importing from one or more asset libraries (e.g. libraries of images, animations, videos, etc.), drawing/creating using one or more design tools (e.g. a text tool, a line tool, a rectangle tool, an ellipse tool, a curve tool, a freehand tool, and/or other design tools), or by otherwise being added to a design page. In some embodiments editable text or a text box containing editable text of a modified image document that has been prepared based on an original image document as described herein is defined by an element record, for example a “text” type element described below. In some embodiments an image resulting from inpainting prepared based on the original image document as described herein is also defined by an element record, for example a “shape” type element as described below.

As will be appreciated, different attributes may be relevant to different element types. By way of example, an element record for a “shape” type element (that is, an element that defines a closed path and may be used to hold an image, video, text, and/or other content) may be as follows:

| Attribute | Note | E.g. |
|---|---|---|
| Type | A value defining the type of the element. | “type”: “Shape” |
| Position | Data defining the position of the element: e.g. an (x, y) | “position”: (100, 100) |
| | coordinate pair defining (for example) the top left point | |
| | of the element. | |
| Size | Data defining the size of the element: e.g. a (width, | “size”: (500, 400) |
| | height) pair. | |
| Rotation | Data defining any rotation of the element. | “rotation”: 0 |
| Opacity | Data defining any opacity of the element (or element | “opacity”: 1 |
| | group). | |
| Path | Data defining the path of the shape the element is in | “path”: “ . . . ” |
| | respect of. This may be a vector graphic (e.g. a scalable | |
| | vector graphic) path. | |
| Media | Data indicating any media that the element holds/is used | “mediaID”: “M12345” |
| | to display. This may, for example, be an image, a video, | |
| | or other media. | |
| Content | Data defining any cropping of the media (if any) the | “mediaCrop”: { . . . } |
| crop | element holds/is used to display. | |
| Text | If the element also defines text, data defining the text | “text”: “Menu” |
| | characters | |
| Text | If the element also defines text, data defining attributes of | “attributes”: { . . . } |
| attributes | the text. | |

In the above example, the shape-type element defines a shape (e.g. a circle, rectangle, triangle, star, or any other closed shape) that can hold/display a media item. Here, the value of the “media” attribute is a “mediaID” that identifies a particular media item (e.g. an image). In other examples, the value of the media attribute may be the media data itself—e.g. raster or vector image data, or other data defining content. In this particular example, the shape-type element also displays text (the word “Menu”, which will be displayed atop the image defined by the media attribute).

As a further example, an element record for a “text” type element may be as follows:

| Key/field | Note | E.g. |
|---|---|---|
| Type | A value defining the type of the element. | “type”: “TEXT”, |
| Position | Data defining the position of the element. | “position”: (100, 100) |
| Size | Data defining the size of the element. | “size”: (500, 400) |
| Rotation | Data defining any rotation of the element. | “rotation”: 0 |
| Opacity | Data defining any opacity of the element. | “opacity”: 1 |
| Text | Data defining the actual text characters | “text”: “Menu” |
| Attributes | Data defining attributes of the text (e.g. font, font size, | “attributes”: { . . . } |
| | font style, font colour, character spacing, line spacing, | |
| | justification, and/or any other relevant attributes) | |

In the present disclosure, an element will be referred to as defining content. The content defined by an element is the actual content that the element causes to be displayed in a design—e.g. text, an image, a video, a pattern, a colour a gradient or other content. In the present examples, the content defined by an element is defined by an attribute of that element—e.g. the “media” attribute of the example “shape” type element above and the “text” attribute of the example “text” type element above.

FIG. 5 depicts a computer implemented method 500 for determining a font for text in an image. The operations of method 500 will be described as being performed by application 204 running on system 202. The operations of method 500 may be performed following or responsive to selection of the control 418 of FIG. 4. The operations may be performed by another application.

At step 502, application 204 extracts from an image a plurality of non-square crops of the image. The extracted non-square crops are portions of the image containing text. The non-square crops may be taken from a portion of the image that corresponds to a line of text. The portion or portions may be identified based on OCR data, as described in more detail herein.

At step 504, feature vectors for the non-square image crops are determined using a first trained machine learning model. In some embodiments, each of the non-square crops is passed through a common shared pre-trained Convolution Neural Network (CNN), with average pooling of three dimensional convolution features to form a one dimensional feature vector for each of the non-square crops. In some embodiments, the CNN model may be MobileNet V3 described in “Searching for MobileNetV3” by Howard et al., which is an ICCV 2019 paper, or may be ResNet50 introduced in the 2015 paper “Deep Residual Learning for Image Recognition” by He Kaiming, et al in Proceedings of the IEEE conference on computer vision and pattern recognition 2016, or other similar models. In some embodiments the CNN model will output a one dimensional feature vector of a predetermined length. The length of the feature vectors may depend on the specific pre-trained model type used and may be fixed for each model type.

The feature vectors corresponding to the non-square crops are combined to form a combined feature vector. In one embodiment combined feature vector is obtained by concatenating the separate feature vectors. The order of the concatenating may depend on the location of the corresponding non-square crops. For example, if the non-square crops are on the left, middle and right side of a portion of the image corresponding to a line of text, then the concatenation may keep the order of the image from left to right. In another embodiment, the combined feature vector may be obtained by summing the separate feature vectors. Alternative ways of combining the feature vectors may also be used.

At step 506, a second trained machine learning model is used to determine font probabilities using the combined feature vector obtained at step 504. The trained machine learning model outputs a (classification) probability value for each of the fonts that the machine learning model is trained with. Each probability value corresponds to the similarity between the text in the non-square crops and the corresponding font. In some embodiments the machine learning model is a Multilayer perceptron (MLP) network with a 2-hidden layered MLP network. The second trained machine learning model is trained based on combined feature vectors for non-square crops of images of text of a known font.

At step 508, a particular font type is determined as a predicted font, based on the font probabilities. System 202 may determine the predicted font to be the font that has the highest probability determined at step 506.

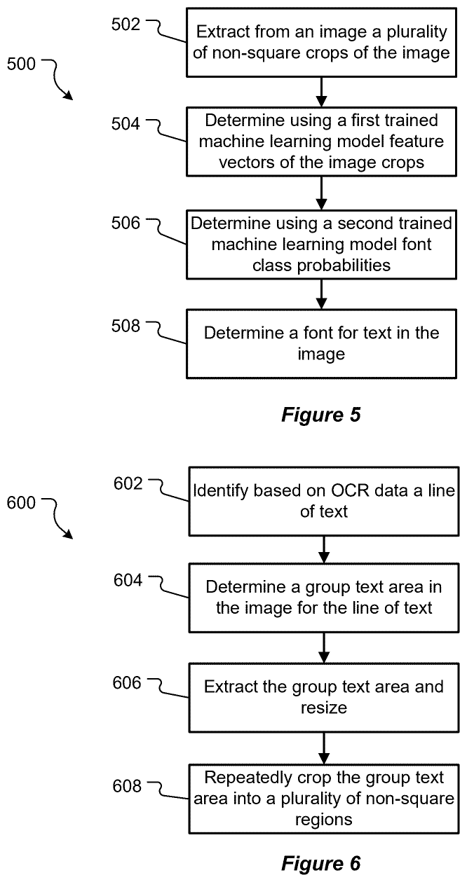

FIG. 6 depicts a computer implemented method 600 for extracting non-square crops from an image. The method 600 may correspond to step 502 of FIG. 5.

At step 602, application 204 identifies a line of text based on OCR data. The OCR data defines extracted text (i.e. a set of glyphs) and layout information, based on an OCR analysis of the image document. In one example, the OCR data is generated by a service, for example utilising the Google® OCR API. The application 204 on system 202 may request an OCR via the API. In other embodiments the system 202 provides the OCR service itself, for example in application 204 or using another application installed on the system 202. The received or generated OCR data includes character data, bounding box information and location information for the extracted text. It may optionally may also include block, paragraph, word, and break information and confidence information on the estimate of the text in the image. Each bounding box may be associated with a group of glyphs, for example a group of glyphs defining a word or a line. The bounding boxes represent an area in the image encompassing the corresponding group of glyphs. Therefore, in embodiments in which the OCR data includes bounding box information for lines of text, step 602 involves identifying such a bounding box. In other embodiments a bounding box for a line of text may first be formed by combining bounding boxes of individual words, based on their alignment and proximity to each other, the alignment and proximity indicating that the words likely form a line. Similarly, the words may have been formed by combining bounding boxes of individual characters.

In some embodiments the received or generated OCR data is filtered, further processed or both. The filtering and/or further processing may improve the reliability of the formation of text boxes containing text for a text editor. The filtering may be based on the confidence information. In some embodiments, where the OCR data includes paragraph or line level information, then paragraph or line information with low confidence is filtered out of the OCR data. The filtering may be automatic, without further user input, or may be semi-automatic, with low confidence paragraphs or lines flagged and a user input requested to indicate whether the low confidence paragraphs should be filtered out or retained.

In some embodiments some additional filtering may be applied, for example to ignore a line that contains a single character that is not a digit and to ignore lines if all the text is symbols. These filtering operations may assist to filter out images that are incorrectly interpreted as text, for example an image of a print of a flower head being interpreted as a star character.

Other filtering operations may be performed, which may be adapted to reflect the OCR service. For example, a service may attempt to construct words from the recognised characters and utilise that to affect the OCR data. This may result in duplicate glyphs with the same character and bounding box. A filtering operation may therefore remove any duplicate glyphs with the same character and bounding box.

In some embodiments received OCR data is transformed into a standardized format. The use of a standardized format may allow different OCR services to be utilised, with the further processing transforming the OCR data from respective different formats of the OCR services to the standardized format.

Referring for example to FIG. 1A the words “It's a party” may be identified as one line and the words “11 pm, #11, 111th street” identified as another line and the words “See you there!” identified as another line. Referring to FIG. 1B the words “Menu” and “1 January” may each be identified as one line and the words “Item 1”, “Item 2”, “Item 3, and “Item 4” each identified as forming other lines.

At step 604 a group text area is determined, which is a portion of the image. The previously described non-square crops are taken from the determined group text area, which may be a portion of the image that corresponds to a line of text, as identified by the OCR data. The group text area may be determined in a number of ways, which will depend in part on the information in the OCR data.

In embodiments in which the OCR data or a processed form of the OCR data identifies bounding boxes of lines of text, then the bounding box of each line of text may be determined to be a group text area. In embodiments in which the OCR data does not identify lines within paragraphs, then all the words that lie on a line within a paragraph are combined and an amalgam of their bounding boxes formed to form a group text area. Thus, all the paragraphs are divided into different group text areas that correspond to lines of text. In some embodiments, the rotation angles of the paragraph bounding boxes from the OCR data are adjusted such that they are all aligned before the lines of text are determined.

In some embodiments, the group text area is formed from a portion of the line of text based on the OCR data. The portion of the line of text may be a predetermined length. For example, the portion of the line may be a predetermined number of words or characters, which may be taken from any part of the determined line, for example starting from the left, starting from the right, or taking the middle section of the line.

At step 606, the group text area is extracted from the image. In some embodiments the group text area is also resized to a standard dimension, while preserving its original aspect ratio. The standard size may be smaller (e.g. in number of pixels) than the image size. In one embodiment, if the group text area is landscape (i.e. has a width greater than its height), then the image height may be resized to s and the image width may be resized to width*(s/height), where width and height are respectively the width and height of the extracted group text area. Similarly, if the group text area is portrait (i.e. has a height greater than its width), then the image height may be resized to height*(s/width) and the width resized to s. In some embodiments the standard size s may be 160 or 224 pixels. In other embodiments another value of pixels is selected. In some embodiments the group text area extracted from the image corresponds to the area defined by a bounding box of the OCR data. In other embodiments the group text area is larger, so as to capture more background from the image. For instance the bounding box may be dilated by a few pixels, for example by up to 5 or up to 10 pixels, in each dimension.

At step 608, the group text area is cropped into a plurality of non-square regions. In some embodiments, if the orientation of the group text area is landscape, the crop dimension is set to be height by 3*height. Similarly, if the orientation of the group text area is portrait, then the crop dimension is set to width by 3*width.

In some embodiments there are three crops into non-square regions. In one example, a first crop from a portrait orientated group text area is extracted from the top-most portion of the group text area, a second crop from the centre portion of the group text area, and a third crop from the bottom-most portion of the group text area. In another example, from a landscape oriented group text area, a first crop is extracted from the leftmost portion, a second crop from the middle portion and a third crop from a rightmost portion of the group text area.

In other embodiments, there may only be two non-square crops of different portions of the group text area, or there may be four or more non-square crops of different portions of the group text area.

In some embodiments, if the group text area has a height equal to its width, then the crop corresponds to the whole image. Accordingly, where three crops are taken, the result is three copies of the group text area (including any resizing as described herein).

As described above, a plurality of non-square crops are taken from the group text area. While each of the non-square crops is preferably of the same size, e.g. having an aspect ratio of 1:3 as described above, in other embodiments the size may differ between crops. To illustrate, when taking three crops from a landscape group text area the left-most and right-most crops may have an aspect ratio of 1:2 and the middle crop may have an aspect ratio of 1:3. Furthermore, not all of the crops need to be non-square and in various embodiments one or more of the crops are non-square and the other crops are square. To illustrate, when taking three crops from a landscape group text area the left-most and right-most crops may have an aspect ratio of 1:1 (i.e. be square) and the middle crop may have an aspect ratio of 1:2 or 1:3 or 1:4 or another non-square ratio. Whatever arrangement of crops is selected, the training of the machine-learning model (see elsewhere herein) should be performed with a corresponding arrangement of crops.

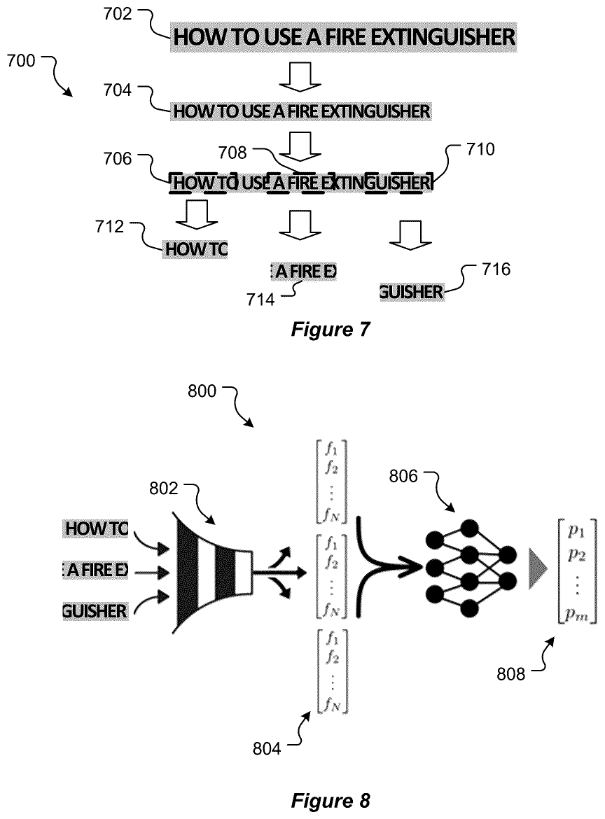

FIG. 7 diagrammatically shows a process of obtaining non-square crops of a group text area according to an embodiment of the method 600. At 702, a group text area corresponding to a line the line of words “HOW TO USE A FIRE EXTINGUISHER” is extracted. This corresponds to steps 602 and 604 of method 600.

At 704, the group text area is resized according to a predetermined standard size keeping the original aspect ratio. Step 704 may correspond to step 606 of method 600.

Three areas of the resized group text area are cropped, from the left, centre and right side of the image corresponding to areas 706, 708 and 710, to produce cropped images 712, 714 and 716. This process corresponds to step 608 of the method 600.

FIG. 8 diagrammatically shows an embodiment of the process of method 500. Cropped images 712, 714 and 716 are passed into a CNN 802 to obtain feature vectors 804. The CNN 802 corresponds to the machine learning model described in step 504. Feature vectors 804 are combined and passed to the second machine learning model 806 to obtain font probabilities 808. Machine learning model 806 may be the machine learning model described at step 506.

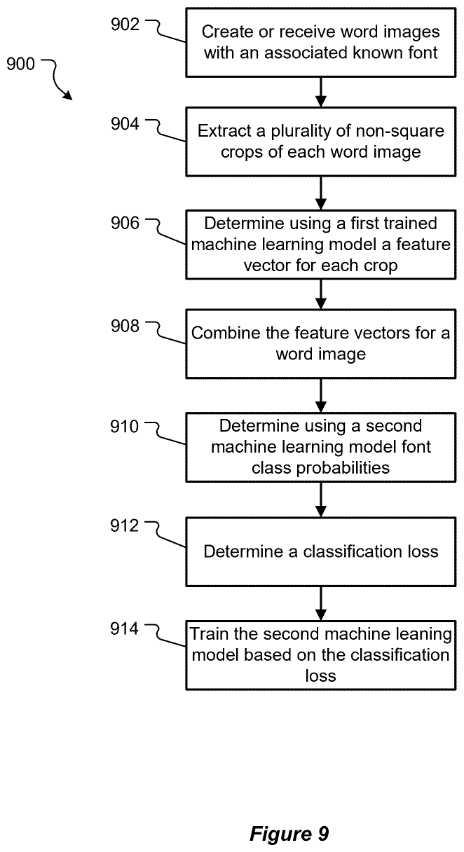

FIG. 9 depicts a computer implemented method 900 for training a machine learning model to predict fonts. In some embodiments the trained machine learning model may be used in step 506 of method 500.

At step 902, system 202 receives training images which include images of text. The text has a known font and at least one known font property. The known font property or properties may include one or more of or be one or more properties selected from group: font style, size, colour or position. Font style may include for example, whether the text is underlined or in bold, whether the text includes effects like strike-through or shadowing and so forth. In some embodiments, different portions of the text may include different font properties. For example, a first portion of the text may be italicised and a second portion of the text may be in bold.

In some embodiments, system 202 may alternatively or in conjunction with receiving the training images, generate additional training images. To generate training images a list of words is gathered, for example the Massachusetts Institute of Technology 10000 word list. A set of fonts is also selected, for example a set of 250 different fonts. The set of fonts may be selected based on the most frequently used fonts, for example, Arial, Times New Roman etc. In some embodiments, the set of fonts may also include lesser used fonts.

From the list of words, a random selection of words is chosen for each font, for example a selection of 600 words, and rendered in each of the different fonts. In some embodiments the words may be rendered in both all uppercase letters and all lowercase letters. In some embodiments, the list of rendered words may contain a higher amount of lowercase words than uppercase words, for example, 60% lowercase lettered words and 40% uppercase lettered words. In other embodiments rendering is in another case or case combination. For example, if the system is expected to be used only to detect lowercase, then training may be in only lower case. In another example, a portion or all of the words are rendered in initial caps. In another example rendering is in both uppercase and lowercase with a 50% split.

In some embodiments, the words are rendered in a random font size. The random font size may for example be selected from a range. The selection may be with a uniform probability distribution across the range. Where the standard size s is 224 pixels, the range may, for example, be 120 to 224 pixels. Each rendered word can be saved as alpha (transparent) images, for example in a PNG format.

From the randomly rendered words, a sentence image is generated by concatenating a plurality of the words into a single line, to form a concatenated image. In some embodiments, a sentence image may also be made up of a single word. The sentence image may then be pasted or otherwise located on or over a randomly selected background image from a set of available background images. In some embodiments the sentence image may comprise multiple lines of horizontal text.

In concatenating the words, typically, words of the same case type (e.g. uppercase) will be selected. In some embodiments, the words selected to be concatenated will be a combination of only uppercase or only lowercase. In some embodiments the concatenated words will be a mix of uppercase and lowercase words. For example, selecting only uppercase words or only lowercase words may have a probability of 45% each and selecting a combination of both lowercase and uppercase words may have a probability of 10%.

In some embodiments, to select the words to be concatenated, a random subset of 20 word images may first be selected. From the 20 words images, up to 7 words may be selected to be concatenated. Each of the up to 7 words selected may then be concatenated together. In some embodiments the gap may be a predetermined length. In other embodiments, the gap between each word may be selected by a random process. If a single word is sampled, then there will not be a gap. The concatenated image may then be saved as a single alpha image.

A random background image is sampled from a set of background images. The concatenated image and the background image are combined to form a composite word image. In some embodiments the composite word image may be formed using the process of alpha blending.

In some embodiments, before combining the background image and concatenated image, system 202 may apply distortions to one or both of the images. For example, the distortions may include, applying transparency to the concatenated image, arc bending to the text of the concatenated image. The arc bending may for example be effected by applying the text on the arc of a circle. The curvature of the arc may be selected by a random process.

In some embodiments the composite word image may be rotated. For example, the angle of rotation may be between 5 and −5 degrees and may be selected by a random process.

In some embodiments, additional or alternative distortions and augmentations may be applied to the composite word image, either as a whole or to one of its component parts. It will be appreciated that combinations of two or more of the distortions and augmentations may be performed. An example of an additional distortion or augmentation is JPEG compressions of various compression rates, with the compression rate being selected by a random process. The selected compression rate may be applied to the composite word image. In some embodiments, down-sampling may be applied to the composite word image. For example, a resolution may be selected by a random process which is lower than the composite word image's resolution. The random resolution may then be applied to the image. In some embodiments, after down-sampling the image, the image is up-scaled. For example, a resolution may be selected by a random process which is higher than the down-sampled image. The resolution may be the same resolution as the composite word image. The image is then up-scaled to the new resolution. In another example, Gaussian noise is applied to the composite word image. In another example colour distortions are applied to the composite word image. For example, a colour shift selected by a random process may be applied to the composite image. In other embodiments, a random crop of the image may be selected.

The list of composite word images may form all or part of the training image set. In some embodiments the training image set will be split into a training image set and a validation image set. In one example there may be a total of 1000 training images and 150 validation images per font type may be generated. The images in the training image set may have or may be resized to have the same standard size described with reference to step 606 of process 600 (see FIG. 6).

At step 904, application 204 extracts a plurality of crops from each word image. The crops are of the same size and from the same locations as the crops described with reference to step 608 of process 600. The process of extracting the crops may be the same as the process described with reference to step 608 of process 600.

At step 906, a feature vector is determined for each crop created at step 904. At step 908, each feature vector corresponding to the non-square crops are combined to form a combined feature vector. At step 910, a second machine learning model is used to determine font probabilities. These steps utilise the same processes described with reference to the process 500, or a process without any material differences and therefore this description is not repeated here so as to avoid duplication.

At step 912, a classification loss is determined based on the class probabilities of the fonts. For example, in one embodiment Multi-class Cross Entropy (MCE) loss is computed between the predicted class probabilities and the ground truth. The ground truth may have a value of 1 for the actual font of the text and 0 for the rest. The MCE loss is provided to the second machine learning model as training data, such that the loss is minimised over time during the training of the model and the predicted font probabilities is as close to the ground truth font as possible. It will be appreciated that in the inference phase, the probability class with the highest probability is output as the final font predicted by the model.

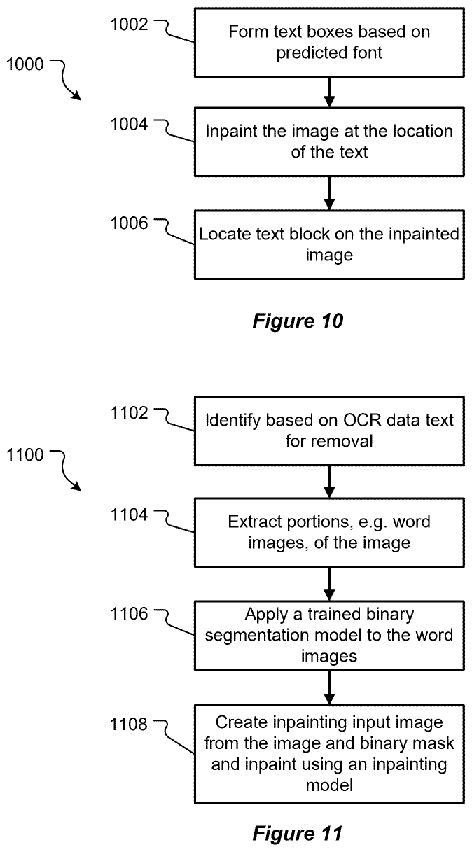

FIG. 10 depicts a computer implemented method 1000 for creating an image with text editable by a text editor. The operations of method 1000 will be described as being performed by application 204 running on system 202. The operations of method 1000 may be performed following or responsive to the selection of the control 418 of FIG. 4 and following the process 500 of FIG. 5, which outputs a determined (predicted) font.

At step 1002 the predicted font is used together with the OCR data to define one or more text boxes. For example, a text box may be formed for each line of text identified from the OCR data. The text box is populated with text that corresponds to the identified text in the OCR data. That text is in the predicted font. Each possible predicted font may match a font that can be used in the text box and is a font of the text editor.

In some embodiments step 1002 includes grouping lines of predicted fonts into a single text box, if they are the same font or are similar fonts and if they are located adjacent to each other and/or if the OCR data indicates that they are in the same paragraph. In other words, step 1002 includes forming text boxes that contain paragraphs of text.

At step 1004 the system 102 generates or receives (for example responsive to a request by the system 102) an inpainted image of the image received in step 502. The inpainting to form the inpainted image replaces areas of the image in which text was detected with an inpainted image. In some embodiments the inpainted image is generated by inpainting performed by an artificial intelligence (AI) image generator, called herein an “inpainting model” or “generative inpainting model”. The inpainting model may operate by a diffusion machine-learning model. An example is using a masked latent diffusion model such as Stable Diffusion Inpainting, where the mask indicates the area of the text to be inpainted by the Stable Diffusion Inpainting model. Other inpainting models may be used, for example a generative adversarial network (GAN) configured for inpainting, such as large mask inpainting (LaMa), as described in Survorov et al., “Resolution-robust Large Mask Inpainting with Fourier Convolutions”, Winter Conference on Applications of Computer Vision (WACV 2022), arXiv:2109.07161.

In some embodiments the system 102 generates a mask to indicate to the inpainting model the areas to inpaint. For instance, if areas of black indicate the areas to be inpainted, then the mask may consist of black boxes or other areas that correspond to the text boxes that are to be located on the image in step 1006 (see below). The inpainting model is then applied to the masked image. In some embodiments instead of masking areas that correspond to text boxes, inpainting at step 1004 may be performed at a finer resolution, for example on a pixel-by-pixel basis. A process for a pixel-by-pixel approach which may be used in step 1004 of FIG. 10 is described herein with reference to FIG. 11.

In step 1006 a modified image document with editable text within it is created by locating the text boxes formed in step 1002 over the inpainted image generated in step 1004. It will be appreciated that the inpainting avoids gaps in the image caused by difference between the editable text and the image text and also allows the text to be edited and relocated without creating gaps in the image where the pre-edited text is located. In some embodiments the location of each text box is shifted vertically upwards. The extent of the shift is based on the font determined for the text box, to visually align the top of the text in the text box with the text in the image. In other words, this step compensates for white space in the font.

FIG. 11 shows a computer implemented method 1100 for text removal for an image. The method may be used to create a modified image document with text removed. As described previously, parts of the method may be used as part of creating a modified image document with editable text. In particular, step 1004 of the method 1000 may include performing steps 1106 and 1108 of method 1100. The operations of method 1100 will be described as being performed by application 204 running on system 202.

In step 1102 text for removal from an image is identified based on OCR data. The identification may be of all or part of identified text in the image. In the case of the part of the identified text, the identified text may comprise a paragraph, a line, a word, a sentence or a collection of one or more glyphs. The identification may be based on user input. For example, a user may select a control (e.g. in UI 400) that indicates that all text in an image should be removed. The method 1100 may complete based on that input, for example without a need for further user input. In another example a user may select a portion of the image and the text for removal is any text within the portion of the image. In a further example, the system 202 may present the identified text based on the OCR data, for example as a list of recognised lines of text displayed to the user and the user may select from the list the text to be removed, for example selecting all or part of a line of text.

In step 1104 the system 202 extracts portions of the image that correspond to the identified text for removal. In some embodiments the extracted portions are resized to a standard dimension and in some embodiments the extracted portions are larger (e.g. are dilated) relative to a bounding box indicated by the OCR data. Steps 1102 and 1104 may involve processes that are the same as or similar to steps 602 to 606 of method 600 and accordingly further description of these steps is not included here, to avoid unnecessary duplication.

In step 1106 a trained binary segmentation model is applied to the extracted image portions from step 1104. The training of the binary segmentation model is with reference to a binary segmentation problem of which pixels in the extracted image portions belong to the text part(s) of the image (as identified based on OCR data) and which pixels belong to the non-text part(s) of the image. Training of the binary segmentation model is preferably performed using images that are extracted images according to steps 1102 and 1104 for which the pixels belonging to the text part(s) are known, or to images with known pixels belonging to text part(s) that correspond to images expected to be extracted by those steps. The training and operation of the binary segmentation model may be on a pixel-by-pixel basis. The output of the binary segmentation model is a binary mask. For example in the binary mask white pixels may represent the predicted presence of text and black pixels represent the predicted presence of non-text or in other words background to the text.

In step 1108 an image for input to an inpainting model is created and input to an inpainting model. The image may be created by multiplying the binary mask generated by step 1106 with its corresponding extracted image portion. For instance, multiplying a pixel from the image with a white pixel may cause the pixel to be masked out and multiplication with a black pixel may cause the pixel to be retained (e.g. retain its RGB value). The effect of this multiplication is to mask out the predicted text part of the image. The inpainting model then generates new image material for the masked-out portions of the image which are then used to create a new image with the text inpainted out.

In some embodiments, instead of applying an inpainting model in step 1108, the masked areas are infilled by copying the neighbouring pixels. This can work well for uniform background colours, for example in documents with plain white background. It will not otherwise extrapolate from the background like an inpainting model can. In some embodiments the method may involve determining if the image created for input to the inpainting model has a background that is uniform or substantially uniform, for example with RGB values within a threshold Euclidean distance. If so the process may forgo applying an inpainting model and inpaint by copying the neighbouring pixels. If not, the system 202 then causes the inpainting model to be used.

Example use cases of various of the computer-implemented methods disclosed herein include editing of text images to change or remove a heading, date, name, address, part or all of a word, sentence, line or paragraph. The editing may be to update information, remove information, correct mistakes, change text attributes or move text to a different location.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

The present disclosure provides user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In some instances the present disclosure may use the terms “first,” “second,” etc. to identify and distinguish between elements or features. When used in this way, these terms are not used in an ordinal sense and are not intended to imply any particular order. For example, a first user input could be termed a second user input or vice versa without departing from the scope of the described examples. Furthermore, when used to differentiate elements or features, a second user input could exist without a first user input or a second user input could occur before a first user input.

In this specification the asterisk symbol * is used to indicate multiplication and any mention of random processes includes quasi-random or similar processes.

In this specification any reference to an example is not intended to limit the generality of the subject in relation to which the example is given. Accordingly, the words “for example” or “e.g.” should be interpreted as “for example and without limitation”.

Background information described in this specification is background information known to the inventors. Reference to this information as background information is not an acknowledgment or suggestion that this background information is prior art or is common general knowledge to a person of ordinary skill in the art.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A method for determining a font for text in an image, the method comprising:
extracting a plurality of crops of an image, the plurality of crops including at least one non-square crop of the image, wherein each non-square crop of the image is located within a group text area, the group text area encompassing a group of the text in the image and determined based on text data associated with the image, the text data comprising location information for text in the image;
determining, by a first trained machine leaning model, a feature vector for each of the crops of the image;
combining the feature vectors to form a combined feature vector;
determining, by a second trained machine learning model provided with the combined feature vector as an input, a class probability value for each of a plurality of classes, the plurality of classes corresponding to fonts; and
determining a font for the group of text in the image as the font having the highest determined class probability value.

2. The method of claim 1, wherein the text data comprises optical character recognition (OCR) text generated by an OCR process and wherein the location information comprises bounding boxes for the OCR text, each bounding box having a location with reference to the image that provides information on a location in the image of the OCR text, and wherein the group text area is an area occupied by one or more of the bounding boxes for the group of text.

3. The method of claim 1, further comprising determining the group of the text in the image for a said crop of the image by a method comprising:
either receiving in the text data, data identifying a line of the text, or identifying a line of the text based on the text data; and
determining the group of text as the line of the text or a part of the line of the text.

4. The method of claim 3, wherein:
a first of the plurality of crops of the image is a portion of the image corresponding to a first portion of the group of text; and
a second of the plurality of crops of the image is a portion of the image corresponding to a second portion of the group of text, different to the first portion of the group of text.

5. The method of claim 4, wherein a third of the plurality of crops of the image is a portion of the image corresponding to a third portion of the group of text, different to the first portion of the group of text and different to the second portion of the group of text.

6. The method of claim 5, wherein the group of text has a landscape orientation and the first, second and third portions correspond to a left-most portion, a middle portion and a right-most portion respectively of the group of text.

7. The method of claim 5, wherein the group of text has a portrait orientation and the first, second and third portions correspond to a top-most portion, a central portion and a bottom-most portion respectively of the group of text.

8. The method of claim 3, wherein the group of text is determined as a part of the line of text and wherein the part of the line of text is determined as a predetermined number of words in the line of text.

9. The method of claim 1, wherein each of the crops of the image are located at a different said location within the group text area and wherein the crops are distributed across the group text area.

10. The method of claim 1, further including determining that the group text area has an aspect ratio equal to an aspect ratio of the crops of the image and in response extracting the group text area as each of the plurality of crops of the image.

11. The method of claim 1, wherein each of the plurality of crops of the image are resized to a predetermined standard size while maintaining aspect ratio, prior to determining the feature vector for the crop.

12. The method of claim 1, wherein the first trained machine learning model comprises a convolutional neural network, with global average pooling of 3D convolutional features to form a 1D feature vector for each of the non-square crops of the image.

13. The method of claim 1, wherein combining the feature vectors is by either concatenation or summation.

14. The method of claim 1, wherein:
the second trained machine-learning model is a classification multi-layer perceptron (MLP) network;
the MLP network is a 2-hidden layered MLP network; and
the MLP network was trained by a process comprising computing multi-class cross entropy loss between determined class probability values and a ground-truth class probabilities.

15. The method of claim 1, wherein the at least one non-square crop has a size dimension along a long axis three times that of a corresponding size dimension along a short axis.

16. The method of claim 1, wherein each of the crops of the image are non-square crops.

17. The method of claim 16, wherein each of the non-square crops have the same aspect ratio.

18. The method of claim 1, further comprising creating an editable document, the editable document comprising the image and editable text located over the image at the group text area, the editable text having the determined font.

19. The method of claim 18, further comprising editing the editable document by a text editor, wherein the text editor has, as available fonts, fonts matching the fonts with corresponding classes.

20. The method of claim 18, wherein creating an editable document comprises inpainting over the group of the text in the image on a pixel-by-pixel basis, wherein the pixels for inpainting are identified by applying a trained binary segmentation model that has been trained to with reference to a binary segmentation problem of which pixels an image portion belong to one or more text parts of the image and which pixels belong to one or more non-text parts of the image portion.
